(19) United States
(12) Patent Application Publication
(10) Pub. No.: US 2026/0036124 A1
(43) Pub. Date: Feb. 5, 2026

(54) TOOTHED WHEEL PUMP COMPRISING MULTIPLE SETS OF INTERNAL-AXLE TOOTHED WHEELS

(71) Applicant: Schwãbische HÜttenwerke Automotive GmbH, Aalen (DE)

(72) Inventor: Uwe Meinig, Bad Saulgau (DE)

(73) Assignee: Schwãbische HÜttenwerke Automotive GmbH, Aalen (DE)

(21) Appl. No.: 19/287,618

(22) Filed: Jul. 31, 2025

(30) Foreign Application Priority Data
Aug. 5, 2024 (DE) 102024122296.4

(51) Int. Cl. F04C 2/08; F04C 15/06

(52) U.S. Cl. CPC F04C 2/084; F04C 15/06; F04C 2240/30; F04C 2240/60

(57) ABSTRACT

A toothed wheel pump comprises:
a pump housing (1) featuring a housing inlet (2), a housing outlet (3) and a first delivery chamber (4) and second delivery chamber (5) which are connected to the housing inlet (2) and the housing outlet (3);
a drive shaft (40);
a first set of internal-axle rotors (11) which are coupled to the drive shaft (40) and can be rotated in the first delivery chamber (4) and comprise an externally toothed first inner rotor (12) and an internally toothed first outer rotor (13) which are in a first toothed engagement in order to deliver fluid from the housing inlet (2) to the housing outlet (3); and
a second set of internal-axle rotors (14) which are coupled to the drive shaft (40) and can be rotated in the second delivery chamber (5) and comprise an externally toothed second inner rotor (15) and an internally toothed second outer rotor (16) which are in a second toothed engagement in order to deliver fluid, wherein
an axial engagement length of the first toothed engagement corresponds to at least 0.7 times the outer diameter of the first outer rotor (13)
and/or
an axial engagement length of the second toothed engagement corresponds to at least 0.7 times the outer diameter of the second outer rotor (16).

### CROSS REFERENCE TO RELATED APPLICATIONS

This claims priority to German Patent Application No. 102024122296.4, filed Aug. 5, 2024, the contents of such application being incorporated by reference herein.

### FIELD OF THE INVENTION

The invention relates to a toothed wheel pump comprising sets of internal-axle toothed wheels for delivering a hydraulic fluid, for example a cooling fluid and/or lubricating fluid. In advantageous applications, it serves to deliver a cooling liquid for cooling a traction battery of an electric vehicle or an electric-combustion hybrid vehicle. The toothed wheel pump is however also suitable for delivering higher-viscosity fluids, such as for example engine lubricating oil, and then in particular for cold-starting a vehicle engine.

### BACKGROUND OF THE INVENTION

Numerous pumps for gaseous and liquid media are used in the drive train sub-systems of combustion-driven and/or electrically driven vehicles. Increasingly, these pumps are operated electrically at variable rotational speeds according to requirement. A common area of application for electric pumps is as cooling media pumps, for example for delivering water-glycol mixtures, oils or also (in individual applications) dielectric cooling liquids. The pumps are embodied as positive-displacement pumps, such as for example toothed wheel pumps and vane pumps, as well as fluid-flow machines, for example centrifugal pumps and side channel pumps. Operating smaller pumps at high on-board voltages of more than 48 V is associated with substantial effort and costs from a safety aspect. Conversely, from a cost aspect, automobile manufacturers wish to avoid vehicle designs which require a third on-board voltage level of for example 48 V in addition to an on-board voltage of 400 or 800 V for the traction motor and 12 V for smaller consumers such as for example lighting. For this reason, electric auxiliary units having an output of up to about 600 W, such as for example electrically driven pumps, continue to typically be operated in passenger motor vehicles via the 12 V on-board supply, which has been common for many decades and is also used for small outputs in electric vehicles, despite the relatively high currents of about 50 A which are generated in the supply lines.

In order to realize delivery rates for these pumps which are as high as possible despite the power uptake being limited to about 50 A, the aim is to use pumps having above-average overall efficiencies. Higher overall efficiencies enable smaller dimensions of the pump's electric drive motor (in most cases, a brushless direct current (BLDC) motor) and the actuating printed circuit board assembly (PCBA) for the motor. This reduces not only the energy input for the drive but also the costs and installation space requirement of the pump.

A comparison using measurement techniques between different pump designs having comparable delivery rates shows that expediently embodied twin-screw and triple-screw pumps can achieve significant advantages in overall efficiencies over conventional toothed wheel pumps, vane pumps and centrifugal pumps, in particular at high rotational speeds and high delivery rates of the pump, i.e. in the typical ranges of the nominal configuration point. Another aspect is the good acoustic properties of screw pumps, which make this pump design interesting in particular for use in electric vehicles having low base noise levels.

A substantial design-related disadvantage of screw pumps is that their design is more costly with regard to the precision demanded of the spindle geometry than that of other positive-displacement pumps and centrifugal pumps. The large sealing gap lengths, which are based on linear contact, between the delivery cells require very narrow component tolerances among the spindles and between the spindles and the associated housing bores to be observed. In addition, screw pumps are difficult to scale in terms of a modular series design, since adapting the delivery volume flow at a given rotational speed level of the drive motor requires a costly reconfiguration of the spindles which is associated with significant tooling costs and a corresponding adaptation of the pump housing.

By comparison, toothed wheel pumps can be adapted relatively easily to the respective requirements with regard to their specific delivery volume (delivery volume per revolution), for example by shortening or lengthening the axial extent of the toothed wheels delivering the fluid. Toothed wheel pumps are also characterized by their simple design and small number of components. Internal-axle toothed wheel pumps, in particular toothed ring pumps such as for example gerotor pumps, can be embodied compactly and therefore make only minor demands on the limited installation space available. Multiple sets of toothed wheels can also be arranged along a shared drive shaft.

DE 10 2019 118 708 A1, incorporated herein by reference, for instance, discloses an internally toothed wheel pump for supplying pressure to a consumer, such as braking systems, transmission controllers, robotics and special-purpose machines. The pump comprises two sets of internal-axle toothed wheels, each having a crescent, arranged along a shared drive shaft and driven by an integrated electric motor via the drive shaft. The pump is a two-stage pump, i.e. one of the sets of toothed wheels is followed by the other in the delivery flow.

DE 33 07 790 A1, incorporated herein by reference, discloses a toothed ring pump comprising gerotor-type sets of toothed wheels arranged along a shared drive shaft. One of the sets of toothed wheels delivers a large volume flow at low pressure, while another delivers a comparatively smaller volume flow at higher pressure. Accordingly, the sets of toothed wheels differ in diameter and length.

DE 10 2021 207 694 A1, incorporated herein by reference, discloses a toothed ring pump (gerotor pump) for delivering lubricating oil, comprising three sets of toothed wheels arranged along a shared drive shaft and driven by an electric motor via the shaft. The electric motor is fastened to the outside of an oil tank. The engine drive shaft protrudes into the oil tank, in which the sets of toothed wheels are arranged, wherein two sets of toothed wheels are arranged in parallel in the delivery flow in order to suction lubricating oil from an adjoining dry sump via a shared inlet and deliver it into the oil tank at a separate outlet in each case. The third set of toothed wheels suction oil in the oil tank and deliver it to a consumer. The sets of toothed wheels which are connected in parallel are longer than the third set of toothed wheels. All three sets of toothed wheels have the same outer diameter.

### SUMMARY OF THE INVENTION

An aspect of the invention is a toothed wheel pump which exhibits better overall efficiencies than conventional positive-displacement pumps and centrifugal pumps, but makes lesser demands on the component tolerances than screw pumps.

Another aspect may be regarded as being that of providing a pump which exhibits a high delivery rate despite small dimensions.

What is desirable is a pump design which can be easily adapted in its design to different delivery requirements and which can easily be scaled for series production.

A toothed wheel pump for delivering a hydraulic fluid, such as an aspect of the invention relates to, comprises a pump housing featuring a housing inlet for the fluid, a housing outlet for the fluid, a first delivery chamber and a second delivery chamber. The housing inlet is connected to a chamber inlet of the first delivery chamber. The housing outlet is connected to a chamber outlet of the first delivery chamber. The toothed wheel pump also comprises a drive shaft, a first set of rotors which are coupled to the drive shaft in order to be rotary-driven, and a second set of rotors which are likewise coupled to the drive shaft in order to be rotary-driven. The first set of rotors (toothed wheels) is rotatably arranged in the first delivery chamber, and the second set of rotors (toothed wheels) is rotatably arranged in the second delivery chamber. The first set of rotors and the second set of rotors are internal-axle rotors. The first set of rotors comprises an externally toothed first inner rotor and an internally toothed first outer rotor, wherein the internal teeth of the first outer rotor are in toothed engagement with the external teeth of the first inner rotor in order to deliver fluid from the housing inlet into the first delivery chamber and from the first delivery chamber to the housing outlet when the first set of rotors are rotary-driven. The second set of rotors comprises an externally toothed second inner rotor and an internally toothed second outer rotor, wherein the internal teeth of the second outer rotor are in a second toothed engagement with the external teeth of the second inner rotor, likewise in order to deliver fluid when the rotors are rotary-driven.

If L₁ is the axial engagement length of the first toothed engagement, L₂ is the axial engagement length of the second toothed engagement, D₁ is the outer diameter of the first outer rotor and D₂ is the outer diameter of the second outer rotor, then it holds in accordance with an aspect of the invention that L₁≥0.7×D₁ and/or L₂≥0.7×D₂.

Advantageously, it holds for the first toothed engagement, i.e. in the toothed engagement of the first set of rotors, that L₁≥0.8×D₁ and/or for the second toothed engagement, i.e. in the toothed engagement of the second set of rotors, that L₂≥0.8×D₂.

For a given specific delivery volume, an aspect of the invention increases (as compared to known pumps) the engagement length of the first toothed engagement and/or the engagement length of the second toothed engagement in relation to the outer diameter of the outer rotor of the respective set of rotors. By decreasing the outer diameter and increasing the engagement length, it is possible to reduce, for a given specific delivery volume, the frictional output over the circumference of the respective outer rotor and on the front-facing surfaces of the respective set of rotors and to increase the overall efficiency of the respective set of rotors and therefore the overall efficiency of the toothed wheel pump as a whole.

Conversely, it is advantageous if one or more of the following relationships holds:

$${L}_{1} \leq 1.5 \times {D}_{1} or {L}_{1} \leq 1.3 \times {D}_{1}$$

$$and / or$$

$${L}_{2} \leq 1.5 \times {D}_{2} or {L}_{2} \leq 1.3 \times {D}_{2} .$$

Limiting the engagement length in relation to the outer diameter counteracts the risk of generating cavitation at high-rotational-speed operating points of the pump.

The toothed wheel pump is a multi-flux pump, wherein the first delivery chamber and the first set of rotors form a first flux, and the second delivery chamber and the second set of rotors form a second flux. In advantageous embodiments, the second delivery chamber is also connected to the housing inlet and the housing outlet. In such embodiments, the housing inlet is connected to a chamber inlet of the second delivery chamber, and the housing outlet is connected to a chamber outlet of the second delivery chamber. When rotary-driven, the second set of rotors then likewise deliver fluid from the housing inlet to the housing outlet through the second delivery chamber. A first fluid flow of the fluid flowing in through the housing inlet is delivered via the first delivery chamber, and a second fluid flow of the fluid flowing in through the housing inlet is delivered via the second delivery chamber. Once they have flowed through the delivery chambers, these fluid flows are merged again and discharged through the housing outlet. The two sets of rotors are hydraulically connected in parallel. Because the overall delivery flow is divided into at least two and preferably precisely two partial volume flows, each individual set of rotors only delivers some, for example half, of the overall amount delivered by the toothed wheel pump. This enables the individual set of rotors to be embodied to be smaller and in particular to exhibit a smaller outer diameter and therefore substantially less friction than mono-flux toothed wheel pumps. If an outer rotor rotates with narrow clearances in the circumferential bearing gap, the frictional torque increases quadratically with the outer diameter of the outer rotor, comparable to the conditions in hydrodynamic slide bearings. This likewise holds for the front-facing surfaces of the set of rotors.

In other multi-flux embodiments, the pump housing can comprise the housing inlet as a first housing inlet and additionally comprise a second housing inlet which is connected to the second delivery chamber via the latter's chamber inlet. When the pump is in operation, a first fluid flow can therefore flow through the first housing inlet into the pump housing, where it can flow into the first delivery chamber, while a second fluid flow flows through the second housing inlet into the pump housing, where it flows into the second delivery chamber. The second delivery chamber can be connected via its chamber outlet to the same housing outlet as the first delivery chamber. If the delivery chambers are connected to the same housing outlet, the fluid flows expelled from the delivery chambers are merged again in the pump housing and discharged as a single fluid flow through the shared housing outlet.

The pump housing can comprise the housing outlet as a first housing outlet and additionally comprise a second housing outlet, wherein the second delivery chamber is connected via its chamber outlet to the second housing outlet. In such embodiments, the fluid flows expelled from the delivery chambers are guided in the pump housing separately from each other to the respective housing outlet, wherein a first fluid flow flows off through the first housing outlet, and a second fluid flow flows off through the second housing outlet. In embodiments comprising a first housing outlet and a second housing outlet, a shared housing inlet can be provided for both delivery chambers, such that the inflowing fluid flow is not divided into the first fluid flow and the second fluid flow until the pump housing, for example not until immediately before it flows into the respective delivery chamber. Alternatively, however, the pump housing can also comprise a first housing inlet and a first housing outlet for the first delivery chamber and a second housing inlet and a second housing outlet for the second delivery chamber, such that a first fluid flow flows in through the first housing inlet, and a second fluid flow flows in through the second housing inlet, and the first and second fluid flows flow separately to and through the respective delivery chamber and also continue to flow off separately through the respective housing outlet.

Because the pump in accordance with an aspect of the invention is divided into at least two sets of rotors, the ratio of the total toothed engagement length to the diameter of the outer rotor of the respective set of rotors can already be increased, thereby decreasing the frictional output and consequently increasing the overall efficiency for the same specific delivery volume, as compared to a toothed wheel pump comprising only one set of rotors (toothed wheels). An aspect of the invention goes a step further and also decreases the outer diameter in relation to the toothed engagement length in the respective set of rotors in its own right, i.e. in the first set of rotors or in the second set of rotors or preferably in each of these sets of rotors, as compared to conventional toothed wheel pumps.

These two features, namely (1) reducing the outer diameter of one or more sets of internal-axle rotors in favor of axially lengthening them and (2) hydraulically connecting sets of rotors in parallel or, figuratively speaking, dividing a set of rotors into multiple sets of rotors, can in particular be realized in combination, but are also each advantageous in their own right. The Applicant reserves the right to direct a separate application to hydraulically connecting sets of rotors in parallel.

The axial extent of the respective set of rotors can advantageously be increased, while simultaneously decreasing the diameter of the outer rotor, to such an extent that the occurrence of cavitation is still reliably avoided even in the upper operating rotational speed range. In order to avoid cavitation, it is advantageous if the first delivery chamber and/or the second delivery chamber is/are filled on both sides. If they are filled on both sides, the length/diameter ratio can be increased as compared to filling on one side only.

In order to further reduce the frictional output on the outer diameter of the first outer rotor and/or second outer rotor between the two axial end portions of the respective outer rotor, the sets of rotors having a decreased diameter can for example be reduced in their outer diameter, for example by being formed or provided with a circumferential recess or with pockets. A circumferential recess between the axial rotor end portions which serve to mount the respective outer rotor forms an annular space, when the pump is in operation, which is filled with the fluid and exhibits a radial extent of for example about 1 mm. This reduces the shear gradient, generated by rotation in the circumferential gap, in the recessed region relative to the mounting end portions of the outer rotor, such that the design of the respective outer rotor, which is elongated in accordance with an aspect of the invention, enables the frictional torque in the circumferential gap to be reduced further.

In preferred embodiments, the toothed wheel pump is a dual-flux pump, such that the housing inlet is only connected to the first delivery chamber and the second delivery chamber, and/or the housing outlet is only connected to the first delivery chamber and the second delivery chamber. Preferably, the first delivery chamber and the second delivery chamber are only connected to the housing inlet and/or only connected to the housing outlet. In principle, however, an aspect of the invention also encompasses embodiments in which one or more other delivery chambers, each comprising another set of internal-axle rotors, are provided in the pump housing and connected to the housing inlet and/or housing outlet. One or more of the above relationships can advantageously likewise hold for the respective other set of rotors.

The delivery chambers each exhibit a low-pressure region and a high-pressure region. With each revolution, the delivery cells formed between the rotors of the respective set of rotors increase in size in the low-pressure region, such that fluid is suctioned into the delivery cells and therefore into the delivery chamber via a chamber inlet located in the low-pressure region. The delivery cells then decrease in size in the rotational direction of the respective set of rotors, such that the fluid is expelled via a chamber outlet located in the high-pressure region at a pressure which is higher than in the low-pressure region.

The chamber inlet of the first delivery chamber and the chamber inlet of the second delivery chamber can advantageously be provided on front-facing sides of the delivery chambers which axially face each other. In such embodiments, the fluid can flow axially into the low-pressure region of the respective delivery chamber. It is advantageous if the fluid flowing in through the housing inlet bifurcates, axially between the delivery chambers, into a first fluid flow and a second fluid flow, wherein the first fluid flow flows directly into the first delivery chamber, and the second fluid flow flows directly into the second delivery chamber.

The chamber outlet of the first delivery chamber and the chamber outlet of the second delivery chamber can advantageously be provided on front-facing sides of the delivery chambers which axially face each other. In such embodiments, the fluid can flow axially out of the high-pressure region of the respective delivery chamber. It is advantageous if the first fluid flow which flows out through the chamber outlet of the first delivery chamber and the second fluid flow which flows out through the chamber outlet of the second delivery chamber converge, axially between the delivery chambers, and then flow off through the housing outlet.

Arranging the chamber inlets and/or chamber outlets in this way can save installation space and decrease the flow resistance between the housing inlet and the respective delivery chamber and/or between the respective delivery chamber and the housing outlet. It is conducive to a compact design and to short inflow paths and/or outflow paths and consequently low flow resistances in the inflow region and/or outflow region if the low-pressure region of the first delivery chamber axially faces opposite the low-pressure region of the second delivery chamber, wherein the two low-pressure regions can fully overlap in relation to the circumferential direction around the respective rotational axis or, as is preferred, exhibit a certain angular offset with respect to each other, i.e. can be offset with respect to each other in relation to their rotational angular position.

The toothed wheel pump is advantageously embodied as a toothed ring pump. In such embodiments, the inner rotor of the respective set of rotors comprises one tooth less than the outer rotor of the same set of rotors. In principle, however, the toothed wheel pump can also be embodied as an internally toothed wheel pump. In such embodiments, a crescent-shaped sealing piece is arranged in the respective delivery chamber in order to fluidically separate the high-pressure region of the respective delivery chamber from the low-pressure region of the same delivery chamber. In another variant, the toothed wheel pump can be embodied as a hybrid of the two internal-axle toothed wheel pumps mentioned, for example by embodying the first set of rotors as a set of toothed rings, for example in a gerotor design, and the second set of rotors as a set of internally toothed wheels (together with a sealing piece).

In preferred embodiments, the first set of rotors and the second set of rotors are of the same type and for example each embodied as a set of toothed rings. The first outer rotor and the second outer rotor can in particular have the same outer diameter. They are preferably also identical over the entirety of their outer circumference. The outer rotors are advantageously identical in length. The engagement length can advantageously correspond to the axial length of the respective outer rotor. In particular, the first outer rotor and the second outer rotor can be geometrically identical. In advantageous embodiments, the first inner rotor and the second inner rotor are geometrically identical. The rotors of the first set of rotors and/or the rotors of the second set of rotors can in particular be identical in length.

Features of the invention are also described in the aspects formulated below. The aspects are formulated in the manner of claims and can substitute for them. Features disclosed in the aspects can also supplement and/or qualify the claims, indicate alternatives with respect to individual features and/or broaden claim features. Bracketed reference signs refer to example embodiments of the invention illustrated below in figures. They do not restrict the features described in the aspects to their literal sense as such, but do conversely indicate preferred ways of realizing the respective feature.
1. A toothed wheel pump for delivering a hydraulic fluid, for example a cooling fluid and/or a lubricating fluid, the toothed wheel pump comprising:
   1.1 a pump housing (1) featuring a housing inlet (2) and a housing outlet (3) for the fluid, a first delivery chamber (4) connected to the housing inlet (2) and the housing outlet (3), and a second delivery chamber (5) which is preferably likewise connected to the housing inlet (2) and the housing outlet (3);
   1.2 a drive shaft (40);
   1.3 a first set of internal-axle rotors (11) which are coupled to the drive shaft (40) and can be rotated in the first delivery chamber (4) and comprise an externally toothed first inner rotor (12) and an internally toothed first outer rotor (13) which are in a first toothed engagement in order to deliver fluid from the housing inlet (2) to the housing outlet (3); and
   1.4 a second set of internal-axle rotors (14) which are coupled to the drive shaft (40) and can be rotated in the second delivery chamber (5) and comprise an externally toothed second inner rotor (15) and an internally toothed second outer rotor (16) which are in a second toothed engagement in order to deliver fluid, wherein
   1.5 an axial engagement length (L₁) of the first toothed engagement corresponds to at least 0.7 times the outer diameter (D₁) of the first outer rotor (13) and/or
   1.6 an axial engagement length (L₂) of the second toothed engagement corresponds to at least 0.7 times the outer diameter (D₂) of the second outer rotor (16).
2. The toothed wheel pump according to the preceding aspect, wherein the axial engagement length (L₁) of the first toothed engagement corresponds to at most 1.5 times or 1.3 times the outer diameter (D₁) of the first outer rotor (13) and/or the axial engagement length (L₂) of the second toothed engagement corresponds to at most 1.5 times or 1.3 times the outer diameter (D₂) of the second outer rotor (16).
3. The toothed wheel pump according to any one of the preceding aspects, wherein the outer diameter (D₁) of the first outer rotor (13) corresponds to at most twice or 1.5 times the root circle diameter (D_{F1}) of the first outer rotor (13) and/or wherein the outer diameter (D₂) of the second outer rotor (16) corresponds to at most twice or 1.5 times the root circle diameter (D_{F2}) of the second outer rotor (16).
4. The toothed wheel pump according to any one of the preceding aspects, wherein the axial engagement length (L₁) of the first toothed engagement and/or the axial engagement length (L₂) of the second toothed engagement corresponds to at least 0.7 times or 0.8 times or 0.9 times the outer diameter (D₁) of the first outer rotor (13) and at least 0.7 times or 0.8 times or 0.9 times the outer diameter (D₂) of the second outer rotor (16).
5. The toothed wheel pump according to any one of the preceding aspects, wherein the axial engagement length (L₁) of the first toothed engagement and/or the axial engagement length (L₂) of the second toothed engagement corresponds to at most 1.5 times or 1.3 times the outer diameter (D₁) of the first outer rotor (13) and at most 1.5 times or 1.3 times the outer diameter (D₂) of the second outer rotor (16).
6. The toothed wheel pump according to any one of the preceding aspects, wherein the axial engagement length (L1) of the first toothed engagement corresponds to at least 0.8 times or 0.9 times the outer diameter (D₁) of the first outer rotor (13) and/or the axial engagement length (L₂) of the second toothed engagement corresponds to at least 0.8 times or 0.9 times the outer diameter (D₂) of the second outer rotor (16).
7. The toothed wheel pump according to any one of the preceding aspects, wherein the outer diameter (D₁) of the first outer rotor (13) and the outer diameter (D₂) of the second outer rotor (16) are the same.
8. The toothed wheel pump according to any one of the preceding aspects, wherein the engagement length (L₁) of the first toothed engagement and the engagement length (L₂) of the second toothed engagement are the same.
9. The toothed wheel pump according to any one of the preceding aspects, wherein the engagement length (L₁) of the first toothed engagement corresponds to the overall length of the first outer rotor (13), and/or the engagement length (L₂) of the second toothed engagement corresponds to the overall length of the second outer rotor (16).
10. The toothed wheel pump according to any one of the preceding aspects, wherein the first inner rotor (12) and the second inner rotor (15) are geometrically identical and/or made of the same material.
11. The toothed wheel pump according to any one of the preceding aspects, wherein the first outer rotor (13) and the second outer rotor (16) are geometrically identical and/or made of the same material.
12. The toothed wheel pump according to any one of the preceding aspects, wherein the second set of rotors (14) is hydraulically connected in parallel with the first set of rotors (11) in order to likewise deliver fluid from the housing inlet (2) to the housing outlet (3).
13. The toothed wheel pump according to any one of the preceding aspects, wherein
   a front-facing side of the first delivery chamber (4) axially faces opposite a front-facing side of the second delivery chamber (5),
   the pump housing (1) comprises a feed line (2a), which is connected to the housing inlet (2), and a drainage line (3a) which is connected to the housing outlet (3), and
   the feed line (2a) and/or the drainage line (3a) extends up to and between the mutually facing front-facing sides of the delivery chambers (4, 5).
14. The toothed wheel pump according to the preceding aspect, wherein the feed line (2a) emerges axially into a low-pressure region of the first delivery chamber (4) on one front-facing side and axially emerges into a low-pressure region of the second delivery chamber (5) on the other front-facing side.
15. The toothed wheel pump according to any one of the immediately preceding two aspects, wherein a high-pressure region of the first delivery chamber (4) and a high-pressure region of the second delivery chamber (5) emerge axially into the drainage line (3a) on front-facing sides of the drainage line (3a) which face axially away from each other.
16. The toothed wheel pump according to any one of the preceding aspects, wherein
   a low-pressure region of the first delivery chamber (4) axially faces opposite a low-pressure region of the second delivery chamber (5), such that the low-pressure region of the first delivery chamber (4) at least partially overlaps with the low-pressure region of the second delivery chamber (5), and/or
   a high-pressure region of the first delivery chamber (4) axially faces opposite a high-pressure region of the second delivery chamber (5), such that the high-pressure region of the first delivery chamber (4) at least partially overlaps with the high-pressure region of the second delivery chamber (5).
17. The toothed wheel pump according to any one of the preceding aspects, wherein
   a front-facing side of the first delivery chamber (4) axially faces opposite a front-facing side of the second delivery chamber (5) and
   the housing inlet (2) is provided on a circumferential wall of the housing (1) and surrounds a virtual straight line (S) which extends between the mutually facing front-facing sides of the delivery chambers (4, 5), orthogonally with respect to a rotational axis (RI, RA) of the first set of rotors (11) and/or second set of rotors (14), and/or
   the housing outlet (3) is provided on a circumferential wall of the housing (1) and surrounds a virtual straight line(S) which extends between the mutually facing front-facing sides of the delivery chambers (4, 5), orthogonally with respect to a rotational axis (R_{I}, R_{A}) of the first set of rotors (11) and/or second set of rotors (14).
18. The toothed wheel pump according to any one of the preceding aspects, wherein at least one of the sets of rotors (11, 14) can be filled with the fluid on both front-facing sides and/or the fluid can be expelled on both front-facing sides of at least one of the sets of rotors (11, 14).
19. The toothed wheel pump according to any one of the preceding aspects, wherein the first inner rotor (12) and the second inner rotor (15) can be rotated about a shared rotational axis (R_{I}), and/or the first outer rotor (13) and the second outer rotor (16) can be rotated about a shared rotational axis (R_{A}).
20. The toothed wheel pump according to any one of the preceding aspects, wherein the first inner rotor (12) and/or the second inner rotor (15) is/are non-rotationally connected to the drive shaft (40) and preferably joined to the drive shaft (40) in a positive fit and/or frictional fit.
21. The toothed wheel pump according to the preceding aspect, wherein the first inner rotor (12) and/or the second inner rotor (15) can be axially moved relative to the drive shaft (40).
22. The toothed wheel pump according to any one of the preceding aspects, wherein the first inner rotor (12) and/or the second inner rotor (15) surround(s) the drive shaft (40).
23. The toothed wheel pump according to the preceding aspect, wherein
   the first inner rotor (12) and/or the second inner rotor (15) comprises or each comprise a groove (17) on an inner circumference, overlapping with the drive shaft (40), and
   the drive shaft (40) is provided with a transverse pin (43) which protrudes from an outer circumference of the drive shaft (40) and protrudes into the groove (17) of the first inner rotor (12) and/or into the groove (17) of the second inner rotor (15),
   such that the respective inner rotor (12; 15) is non-rotationally connected to the drive shaft (40) in the engagement between the transverse pin (43) and the groove (17).
24. The toothed wheel pump according to the preceding aspect, wherein the transverse pin (43) extends through the drive shaft (40) and protrudes on both sides from the outer circumference of the drive shaft (40), and the first inner rotor (12) and/or the second inner rotor (15) comprise(s) mutually opposing grooves (17) on the inner circumference into which the transverse pin (43) protrudes.
25. The toothed wheel pump according to any one of the immediately preceding two aspects, wherein the respective groove (17) extends up to a front-facing end of the first inner rotor (12) or second inner rotor (15), preferably up to a front-facing end which faces away from the other inner rotor (12; 15) in each case.
26. The toothed wheel pump according to any one of the preceding aspects, wherein the first inner rotor (12), the second inner rotor (15) and the drive shaft (40) are each formed in one piece, and the first inner rotor (12) and/or the second inner rotor (15) directly surround(s) the drive shaft (40).
27. The toothed wheel pump according to any one of aspects 1 to 22, wherein the first inner rotor (12) is non-rotationally joined to a first bearing sleeve (41) and/or the second inner rotor (15) is non-rotationally joined to a second bearing sleeve (42), and the respective bearing sleeve (41; 42) is directly connected to the drive shaft (40), non-rotationally but preferably such that it can be moved axially, in a positive fit.
28. The toothed wheel pump according to any one of the preceding aspects, comprising an electric drive motor (55) featuring a stator (56) and a rotor (57) and which is arranged coaxially with the drive shaft (40) in an engine housing (50) which axially adjoins the pump housing (1).
29. The toothed wheel pump according to any one of the preceding aspects, comprising an electric drive motor (55) featuring a stator (56) and a rotor (57) and which is non-rotationally assembled on or on top of the drive shaft (40) and preferably joined to the drive shaft (40) in a positive fit and/or frictional fit.
30. The toothed wheel pump according to the preceding aspect, wherein the drive shaft (40) supports the rotor (57) in a radially floating manner.
31. The toothed wheel pump according to any one of the immediately preceding three aspects, wherein
   the drive motor (55) is arranged in an engine housing (50),
   the drive shaft (40) protrudes through a front-facing wall which extends axially between the pump housing (1) and the engine housing (50), and
   the front-facing wall forms a shaft bearing (53), preferably a radial slide bearing, for the drive shaft (40).
32. The toothed wheel pump according to the preceding aspect, wherein the pump housing (1) and the engine housing (50) are joined, and the engine housing (50) forms the front-facing wall.
33. The toothed wheel pump according to any one of the immediately preceding two aspects, wherein the pump housing (1) comprises a centering structure (1a) and the engine housing (50) comprises a complementary centering structure (54) which are in centering engagement with each other and thereby center the engine housing (50) on the pump housing (1) in relation to the rotational axis (R_{I}) of the drive shaft (40).
34. The toothed wheel pump according to the preceding aspect, wherein one of the centering structure (1a) and the complementary centering structure (54) exhibits an outer circumference, and the other of the centering structure (1a) and the complementary centering structure (54) exhibits an inner circumference which surrounds the outer circumference in a centering contact.
35. The toothed wheel pump according to the preceding aspect, wherein one of the centering structure (1a) and the complementary centering structure (54) is a centering collar (54) which exhibits the inner circumference which is in centering engagement.
36. The toothed wheel pump according to any one of the preceding aspects, each in combination with aspect 28, wherein the drive shaft (40) is axially supported on the engine housing (50), preferably on an engine cover (58) of the engine housing (50).
37. The toothed wheel pump according to any one of the preceding aspects, wherein the drive shaft (40) is rotatably mounted in a shaft bearing (10) of the pump housing (1), axially between the sets of rotors (11, 14), wherein the shaft bearing (10) is preferably a radial slide bearing.
38. The toothed wheel pump according to any one of the preceding aspects, comprising a front-facing wall (20; 50) which is fastened to the pump housing (1) and closes off the first delivery chamber (4) on a front-facing side which faces away from the second delivery chamber (5), and comprises an axial passage through which the drive shaft (40) extends.
39. The toothed wheel pump according to the preceding aspect, wherein the front-facing wall (20; 50) forms a shaft bearing (53), preferably a radial slide bearing, for the drive shaft (40).
40. The toothed wheel pump according to any one of the immediately preceding two aspects, wherein a first housing cover (20) or the engine housing (50) according to aspect 28 forms the front-facing wall.
41. The toothed wheel pump according to any one of the immediately preceding three aspects, wherein the front-facing wall (20; 50) comprises a hollow-shaped outer chamber inlet (21; 51) which is connected to the housing inlet (2) via a feed channel (7a).
42. The toothed wheel pump according to any one of the immediately preceding four aspects, wherein the front-facing wall (20; 50) comprises a hollow-shaped outer chamber outlet (22; 52) which is connected to the housing outlet (3) via a drainage channel (9a).
43. The toothed wheel pump according to any one of the preceding aspects, comprising a second housing cover (30) which is fastened to the pump housing (1) and closes off the second delivery chamber (5) on a front-facing side which faces away from the first delivery chamber (4).
44. The toothed wheel pump according to the preceding aspect, wherein the second housing cover (30) forms a shaft bearing (33), preferably a radial slide bearing, for the drive shaft (40).
45. The toothed wheel pump according to any one of the immediately preceding two aspects, wherein the drive shaft (40) is axially supported on the second housing cover (30).
46. The toothed wheel pump according to any one of the immediately preceding three aspects, wherein the pump housing (1) comprises a centering structure (1b) and the second housing cover (30) comprises a complementary centering structure (34), which are in centring engagement with each other and thereby center the second housing cover (30) on the pump housing (1) in relation to the rotational axis (R_{I}) of the drive shaft (40).
47. The toothed wheel pump according to the preceding aspect, wherein one of the centring structure (1b) and the complementary centring structure (34) exhibits an outer circumference, and the other of the centring structure (1b) and the complementary centring structure (34) exhibits an inner circumference which surrounds the outer circumference in a centring contact.
48. The toothed wheel pump according to the preceding aspect, wherein one of the centring structure (1b) and the complementary centring structure (34) is a centring collar (34) which exhibits the inner circumference which is in centring engagement.
49. The toothed wheel pump according to any one of the immediately preceding three aspects, wherein the second housing cover (30) comprises a hollow-shaped outer chamber inlet (31) which is connected to the housing inlet (2) via a feed channel (7b).
50. The toothed wheel pump according to any one of the immediately preceding four aspects, wherein the second housing cover (30) comprises a hollow-shaped outer chamber outlet (32) which is connected to the housing outlet (3) via a drainage channel (9b).
51. The toothed wheel pump according to any one of the preceding aspects, wherein
   the first delivery chamber (4) exhibits a low-pressure region, a high-pressure region and a separating stay (Tₜ₄) between the low-pressure region and the high-pressure region in the circumferential direction in order to fluidically separate the high-pressure region and the low-pressure region of the first delivery chamber (4) from each other,
   the second delivery chamber (5) exhibits a low-pressure region, a high-pressure region and a separating stay (Tₜ₅) between the low-pressure region and the high-pressure region in the circumferential direction in order to fluidically separate the high-pressure region and the low-pressure region of the second delivery chamber (5) from each other, and wherein
   the separating stay (Tₜ₄) of the first delivery chamber (4) exhibits an angular offset (2α) with respect to the separating stay (Tₜ₅) of the second delivery chamber (5) as measured in the circumferential direction about a rotational axis (R_{I}) of the first set of rotors (11) and/or second set of rotors (14), such that when the sets of rotors (11, 14) rotate, the expelling process of the first set of rotors (11) per revolution and the expelling process of the second set of rotors (14) per revolution are phase-shifted in accordance with the angular offset (2α).
52. The toothed wheel pump according to the preceding aspect, wherein the angular offset (2α) measures at least a quarter and at most three quarters of a tooth width of the first outer rotor (13) as measured in the circumferential direction on the pitch circle and/or at least a quarter and at most three quarters of a tooth width of the second outer rotor (16) as measured in the circumferential direction on the pitch circle.
53. The toothed wheel pump according to any one of the preceding aspects, wherein in a slide bearing gap which the first outer rotor (13) forms with a circumferential wall of the first delivery chamber (4) and/or in a slide bearing gap which the second outer rotor (16) forms with a circumferential wall of the second delivery chamber (5), one or more local recesses (4a; 16b) is/are formed in the respective circumferential wall or on the outer circumference of the respective outer rotor (13, 16) in order to decrease a shear gradient of a fluid in the slide bearing gap, wherein the shear gradient acts as a frictional torque in the circumferential direction, when the respective outer rotor (13, 16) rotates in the respective slide bearing gap.
54. The toothed wheel pump according to any one of the preceding aspects, wherein one or more axial grooves or pocket-shaped recesses (4a) or one or more annularly circumferential recesses (16b) is/are formed on the outer circumference of the respective outer rotor (13, 16).
55. The toothed wheel pump according to any one of the preceding aspects, wherein the respective outer rotor (13, 16) comprises one or more recesses (16b) on the outer circumference and, axially to the left and right of the one or more recesses (16b), a circumferentially smooth circumferential strip in each case, in the region of which the respective outer rotor (13, 16) forms a support gap with the circumferential wall of the respective delivery chamber (4, 5).
56. The toothed wheel pump according to any one of aspects 1 to 52, wherein the first outer rotor (13) and/or the second outer rotor (16) comprises a first rotor axial portion having a first outer diameter and a second rotor axial portion (16a) having a second outer diameter, wherein the first outer diameter is greater than the second outer diameter, and wherein the delivery chamber (4, 5) in which the respective outer rotor (13, 16) is arranged comprises, overlapping with the first rotor axial portion, a first chamber axial portion (5a) having a first inner diameter and, overlapping with the second rotor axial portion (16a), a second chamber axial portion having a second inner diameter, and wherein like the first outer diameter, the first inner diameter is greater than the second inner diameter which is adapted to the second outer diameter.
57. The toothed wheel pump according to the preceding aspect, wherein the first rotor axial portion is shorter than the second rotor axial portion (16a) having a reduced outer diameter, and the first chamber axial portion (5a) is longer than the second chamber axial portion having a reduced inner diameter, such that a support gap is obtained in each of the first rotor axial portion and the second chamber axial portion, and a circumferential gap (5a, 16a) which is radially wider than the support gaps is obtained axially between the first rotor axial portion and the second chamber axial portion
58. The toothed wheel pump according to any one of the preceding aspects, wherein the pump housing (1) forms a circumferential wall of the first delivery chamber (4) and a circumferential wall of the second delivery chamber (5), and the respective circumferential wall forms a radial slide bearing for the respective outer rotor (13, 16).
59. The toothed wheel pump according to any one of the preceding aspects, wherein
   the pump housing (1) comprises a front-facing wall which respectively forms an inner front-facing wall for the delivery chambers (4, 5), and
   the first delivery chamber (4) extends in an axial direction from the inner front-facing wall up to an open front-facing end of the pump housing (1), and the second delivery chamber (5) extends in the opposite axial direction from the inner front-facing wall up to an open front-facing end of the pump housing (1), and
   they are closed off by means of an outer front-facing wall (20, 30; 30, 50) which is joined to the pump housing (1).
60. The toothed wheel pump according to the preceding aspect, wherein one front-facing side of the inner front-facing wall comprises an inner chamber inlet (6a) for the first delivery chamber (4), and the other front-facing side of the inner front-facing wall comprises an inner chamber inlet (6b) for the second delivery chamber (5), and a feed line (2a) extends in the inner front-facing wall in a direction transverse to the drive shaft (40) and connects the housing inlet (2) to the inner chamber inlets (6a, 6b).
61. The toothed wheel pump according to any one of the immediately preceding two aspects, wherein one front-facing side of the inner front-facing wall comprises an inner chamber outlet (8a) for the first delivery chamber (4), and the other front-facing side of the inner front-facing wall comprises an inner chamber outlet (8b) for the second delivery chamber (5), and a drainage line (3a) extends in the inner front-facing wall in a direction transverse to the drive shaft (40) and connects the housing outlet (3) to the inner chamber outlets (8a, 8b).
62. The toothed wheel pump according to aspect 56 or aspect 57, wherein the housing inlet (2) and/or the housing outlet (3) is/are arranged on an outer circumference of the pump housing (1) axially level with the inner front-facing wall.
63. The toothed wheel pump according to the preceding aspect, wherein the housing inlet (2) and the feed line (2a) extend in alignment transversely to the drive shaft (40), and/or the housing inlet (3) and the drainage line (3a) extend in alignment transversely to the drive shaft (40).
64. The toothed pump according to any one of the preceding aspects, wherein at least one of the outer rotors (13, 16) and/or at least one of the inner rotors (12, 15) is/are formed from plastic, for example PEEK.
65. The toothed wheel pump according to any one of the preceding aspects, wherein at least one of the outer rotors (13, 16) and/or at least one of the inner rotors (12, 15) is/are formed from a polyketone, polyimide, PPS or thermosetting plastic.
66. The toothed wheel pump according to any one of the preceding aspects, wherein at least one of the outer rotors (13, 16) and/or at least one of the inner rotors (12, 15) is/are formed from plastic filled with fluorine and/or carbon.
67. The toothed wheel pump according to any one of the preceding aspects, wherein the outer rotors (13, 16) are formed from plastic, for example PEEK.
68. The toothed wheel pump according to any one of the preceding aspects, wherein the inner rotors (12, 15) are formed from a metal material, for example an iron-based or aluminum-based sintered material.
69. The toothed wheel pump according to any one of the preceding aspects, wherein the pump housing (1) is/are formed from a metal material, for example an iron-based or aluminum-based cast material.
70. The toothed wheel pump according to any one of the preceding aspects, wherein the pump housing (1) forms a circumferential wall of the first delivery chamber (4) and a circumferential wall of the second delivery chamber (5), and the respective circumferential wall forms a radial slide bearing for the respective outer rotor (13, 16).
71. The toothed wheel pump according to the preceding aspect, wherein the pump housing (1) or at least the respective circumferential wall is formed from a metal material, for example an iron-based or aluminum-based cast material.
72. The toothed wheel pump according to aspect 70, wherein the pump housing (1) or at least the respective circumferential wall is formed from a plastic, for example a thermosetting plastic or PPS.
73. The toothed wheel pump according to aspect 70 or 72, wherein the pump housing (1) or at least the respective circumferential wall is formed from PPS filled with PTFE.
74. The toothed wheel pump according to any one of the preceding aspects, used to deliver a cooling and/or lubricating fluid in a cooling and/or lubricating circuit of an electrically driven and/or combustion-driven motor vehicle.
75. The toothed wheel pump according to any one of the preceding aspects, used to deliver a cooling fluid, for example a dielectric liquid, for directly cooling a vehicle traction battery.

### BRIEF DESCRIPTION OF THE DRAWINGS

Example embodiments of the invention are described below on the basis of figures. Features disclosed by the example embodiments, each individually and in any combination of features, advantageously develop the subject matter of the claims, the aspects and the other embodiments described above. In the figures:

FIG. 1 shows a toothed wheel pump of a first example embodiment in an isometric view onto components of the toothed wheel pump which are shown individually along a central axis;

FIG. 2 shows the toothed wheel pump comprising sets of rotors arranged axially next to each other, in a longitudinal section;

FIG. 3 shows the toothed wheel pump in a cross-section in the region of one of the sets of rotors;

FIG. 4 shows one of the sets of rotors comprising a rotational mounting according to a first variant;

FIG. 5 shows one of the sets of rotors comprising a rotational mounting according to a second variant;

FIG. 6 shows one of the sets of rotors comprising a rotational mounting according to a third variant;

FIG. 7 shows a second example embodiment of a toothed wheel pump comprising sets of rotors arranged axially next to each other, in a longitudinal section;

FIG. 8 shows the sets of rotors from FIG. 7 only, in a longitudinal section;

FIG. 9 shows the set of rotors from FIG. 3 only, in a cross-section; and

FIG. 10 shows a chamber inlet and a chamber outlet of a first delivery chamber, superimposed with a chamber inlet and a chamber outlet of a second delivery chamber, each in a plan view.

### DETAILED DESCRIPTION OF EXEMPLARY EMBODIMENTS

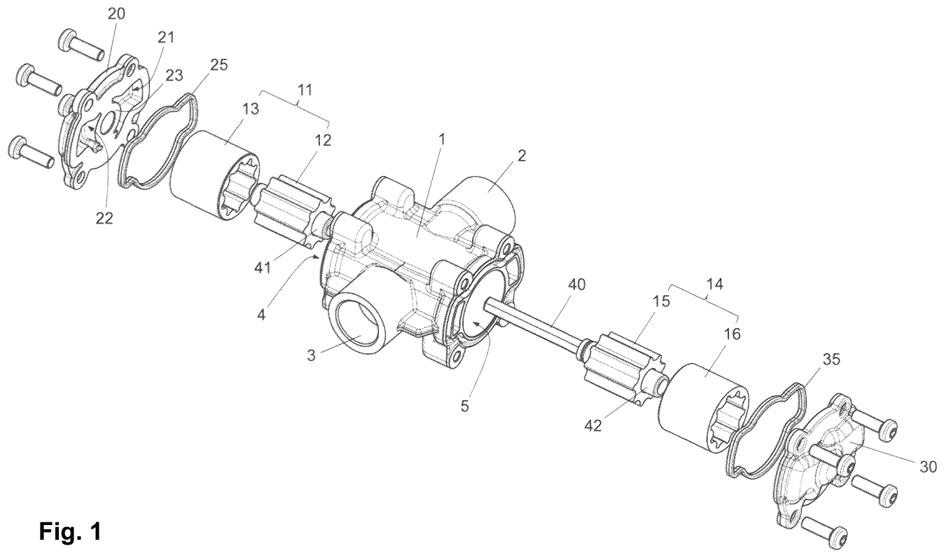

The isometric view in FIG. 1 shows components of an internal-axle toothed wheel pump of a first example embodiment. In the exploded representation, the components can be individually seen along a central longitudinal axis of the toothed wheel pump. The toothed wheel pump comprises a pump housing 1 featuring a housing inlet 2 and a housing outlet 3 for a fluid to be delivered, for example a cooling and/or lubricating fluid or a working fluid. The toothed wheel pump can in particular be used to deliver a cooling fluid, for example, a dielectric fluid, for directly cooling a vehicle traction battery.

The toothed wheel pump comprises a first set of rotors 11, comprising a first inner rotor 12 and a first outer rotor 13, and a second set of rotors 14 comprising a second inner rotor 15 and a second outer rotor 16. The inner rotors 12 and 15 each exhibit external teeth, and the outer rotors 13 and 16 each exhibit internal teeth. The inner rotors 12 and 15 can be rotated about a shared rotational axis R_{I}. The rotational axis of the respective outer rotor 13 and 16 extends eccentrically parallel to the rotational axis R_{I}. A first delivery chamber 4 for the first set of rotors 11 and a second delivery chamber 5 for the second set of rotors 14 are formed in the pump housing 1. The delivery chambers 4 and 5 extend along the rotational axis R_{I} which, as is preferred but merely by way of example, simultaneously forms the central longitudinal axis of the pump housing 1. They can be axially aligned or, as is preferred, offset relative to each other by a certain angle around the rotational axis R_{I} and pivoted relative to each other, so to speak, with the eccentricity as a pivot arm. The delivery chambers 4 and 5 are open on axial front-facing sides of the pump housing 1, such that the first set of rotors 11 can be inserted axially into the first delivery chamber 4 via one open front-facing side, and the second set of rotors 14 can be inserted axially into the second delivery chamber 5 via the other open front-facing side.

A shared drive shaft 40 which can be rotated about the rotational axis R_{I} is provided for rotary-driving the sets of rotors 11 and 14. As is preferred, but merely by way of example, the drive shaft 40 drives the inner rotors 12 and 15, which in their respective toothed engagement drive the associated outer rotor 13 and 16, respectively. A rotational coupling is established between the drive shaft 40 and each of the inner rotors 12 and 15 by non-rotationally connecting each of the inner rotors 12 and 15 to the drive shaft 40, wherein the first inner rotor 12 is non-rotationally seated on a first bearing sleeve 41 which is in a rotationally secured engagement with the drive shaft 40, and the second inner rotor 15 is non-rotationally seated on a second bearing sleeve 42 which is likewise in a rotationally secured engagement with the drive shaft 40. The bearing sleeves 41 and 42 can be moved axially back and forth along the drive shaft 40 in the rotationally secured engagement.

The toothed wheel pump comprises a first housing cover 20, for closing off the first delivery chamber 4 on its front-facing side, and a second housing cover 30 for closing off the second delivery chamber 5 on its front-facing side. An axial sealing ring 25 is provided on the front-facing side of the delivery chamber 4 in order to close it off in a fluid-tight seal, and an axial sealing ring 35 is provided on the front-facing side of the delivery chamber 5 in order to close it off in a fluid-tight seal. As is preferred, but merely by way of example, the housing covers 20 and 30 each comprise a hollow-shaped chamber inlet and a hollow-shaped chamber outlet on their front-facing sides facing the pump housing 1 for filling and emptying, on both sides, the delivery cells formed by the sets of rotors 11 and 14 when in toothed engagement. The chamber inlet 21 and chamber outlet 22 of the housing cover 20 can be seen. The housing cover 20 also comprises a shaft receptacle 23 which in the example embodiment is formed as an axial passage through which the drive shaft 40 extends when assembled, such that it can be coupled to an external drive outside the pump housing 1. The housing cover 30 likewise comprises such a chamber inlet and chamber outlet and preferably also such a shaft receptacle.

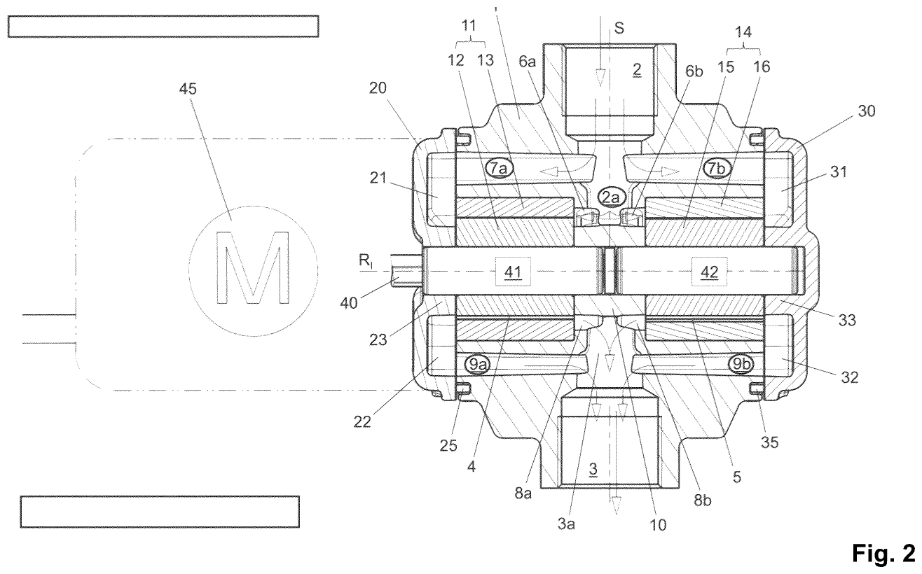

FIG. 2 shows the toothed wheel pump when assembled, in a longitudinal section in which the rotational axis RI of the drive shaft 40 extends. The delivery chambers 4 and 5 and the sets of rotors 11 and 14 accommodated in them are arranged coaxially along the rotational axis R_{I}, wherein the inner rotors 12 and 15 are arranged coaxially along the shared rotational axis RI. The outer rotors 13 and 16 can advantageously likewise be arranged coaxially along a shared rotational axis. The preferably shared rotational axis of the outer rotors 13 and 16 extends eccentrically parallel to the rotational axis R_{I}, i.e. it does not extend in the plane of the longitudinal section shown. In principle, however, the outer rotors 13 and 16 can also each exhibit a separate rotational axis, wherein the rotational axis of one outer rotor would be offset with respect to the rotational axis of the other outer rotor in relation to the rotational axis R_{I} by a certain rotational angle.

The delivery chambers 4 and 5 extend from the respective front-facing side of the pump housing 1 towards an axially central region of the pump housing 1. In the central region, the pump housing 1 comprises a housing front-facing wall which forms an inner chamber front-facing wall for each of the delivery chambers 4 and 5. From the central housing front-facing wall, the pump housing 1 forms a circumferential wall for each of the delivery chambers 4 and 5, which surrounds the respective outer rotor 13 and 16 and forms a slide bearing gap with the respective outer rotor 13 and 16 over the outer circumference of the respective outer rotor 13 and 16.

In order to minimize the frictional output generated over the circumference in the respective slide bearing gap, the sets of rotors 11 and 14 are unusually long in the axial direction in relation to their radial extent. Due to the large length and conversely small outer diameter of the outer rotors 13 and 16, the front-facing surfaces of the sets of rotors 11 and 14 are decreased in size, such that the frictional output or frictional loss in the axial sealing gaps is also decreased. The toothed engagement length of the rotors of the respective set of rotors 11 and 14, as measured in the axial direction, is in particular suitable as a measure of the length, since the toothed engagement length determines in part the specific delivery volume of the respective set of rotors.

The housing inlet 2 and the housing outlet 3 are each arranged on the circumference of the pump housing 1. In the example embodiment, they are diametrically opposite each other across the rotational axis R_{I}, i.e. angularly offset with respect to each other by 180° over the circumference of the pump housing 1. The housing inlet 2 and the housing outlet 3 are arranged axially level with the housing front-facing wall.

The housing inlet 2 emerges in the radial direction on the circumference of the pump housing 1 and extends in the radial direction towards the rotational axis R_{I}. In a radial extension of the housing inlet 2, a central feed line 2a extends up to and axially between the delivery chambers 4 and 5. The front-facing side of the delivery chamber 4 which axially faces the delivery chamber 5 comprises an inner chamber inlet 6a. The front-facing side of the delivery chamber 5 which axially faces the delivery chamber 4 comprises an inner chamber inlet 6b. The chamber inlet 6a and the chamber inlet 6b each divert from the central feed line 2a in the axial direction. The delivery chambers 4 and 5 are therefore filled on their mutually facing inner front-facing sides via the respective chamber inlet 6a and 6b.

The housing outlet 3 emerges in the radial direction on the circumference of the pump housing 1 and extends in the radial direction towards the rotational axis R_{I}. In a radial extension of the housing outlet 3, a central drainage line 3a extends up to and axially between the delivery chambers 4 and 5. The front-facing side of the delivery chamber 4 which axially faces the delivery chamber 5 comprises an inner chamber outlet 8a. The front-facing side of the delivery chamber 5 which axially faces the delivery chamber 4 comprises an inner chamber outlet 8b. The chamber outlet 8a and the chamber outlet 8b each emerge into the central drainage line 3a in the axial direction. The fluid is therefore expelled on the mutually facing inner front-facing sides of the delivery chambers 4 and 5 via the respective chamber outlet 8a and 8b.

The housing inlet 2 and the housing outlet 3 surround an axis S which extends in a transverse direction to the drive shaft 40 and axially between the sets of rotors 11 and 14. In the example embodiment, the transverse axis S points radially with respect to the rotational axis R_{I}. It can however also cross the rotational axis R_{I} at a small distance. The inflow for the fluid can be linear from the outer opening of the housing inlet 2 up to and between the chamber inlets 6a and 6b. The outflow for the fluid can be linear from the outer opening of the housing outlet 3 up to and between the chamber outlets 8a and 8b. The pump housing 1 and the sets of rotors 11 and 14 accommodated in it can be mirror-symmetrical in relation to a cross-sectional plane in which the transverse axis S extends.

Downstream of the housing inlet 2, a feed channel 7a which is a left-hand feed channel in FIG. 2 and a feed channel 7b which is a right-hand feed channel in FIG. 2 divert from the central feed line 2a in order to also fill each of the delivery chambers 4 and 5 via their outer front-facing sides which face axially away from each other. In the example embodiment, the feed channels 7a and 7b divert from the central feed line 2a radially between the housing inlet 2 and the chamber inlets 6a and 6b. The feed channels 7a and 7b each extend from the central feed line 2a in the axial direction to the left and right up to the front-facing sides of the pump housing 1. The feed channel 7a emerges into the outer chamber inlet 21 of the delivery chamber 4 which can already be seen in FIG. 1, and the feed channel 7b emerges into an outer chamber inlet 31 of the delivery chamber 5. The chamber inlets 21 and 31 are each hollow-shaped recesses on the inner front-facing sides of the housing covers 20 and 30. In these recesses or outer chamber inlets 21 and 31, the fluid initially flows radially inwards and then in the axial direction into the respective delivery chamber 4 and 5. Filling on both sides counteracts cavitation-forming in the suction region or low-pressure region of the respective delivery chamber 4 and 5.

Downstream of the inner chamber outlets 8a and 8b and upstream of the housing outlet 2, a drainage channel 9a which is a left-hand drainage channel in FIG. 2 and a drainage channel 9b which is a right-hand drainage channel in FIG. 2 emerge into the central drainage line 3a in order to also empty each of the delivery chambers 4 and 5 via their outer front-facing sides which face axially away from each other. In the example embodiment, the drainage channels 9a and 9b emerge into the central discharge line 3a radially between the housing outlet 3 and the chamber outlets 8a and 8b. The drainage channels 9a and 9b each extend from the central discharge line 3a in the axial direction to the left and right up to the front-facing sides of the pump housing 1. The drainage channel 9a emerges into the outer chamber outlet 22 of the delivery chamber 4 which can already be seen in FIG. 1, and the drainage channel 9b emerges into an outer chamber outlet 32 of the delivery chamber 5. The chamber outlets 22 and 32 are each hollow-shaped recesses on the inner front-facing sides of the housing covers 20 and 30. In these recesses or outer chamber outlets 22 and 32, the fluid initially flows radially outwards, is deflected and flows through the drainage channels 9a and 9b and from there into the central discharge line 3a, from which it flows off via the housing outlet 3 towards the consumer, for example a traction battery of a full-electric or hybrid motor vehicle, wherein said traction battery is to be cooled using the fluid.

The pump housing 1 forms a shaft bearing 10, axially between the sets of rotors 11 and 14 in the region of the central housing front-facing wall, for rotationally mounting the sets of rotors 11 and 14, wherein the shaft bearing 10 forms a radial rotary slide bearing directly with the bearing sleeve 41 for the first set of rotors 11 and with the bearing sleeve 42 for the second set of rotors 14. The central feed line 2a and/or the central drainage line 3a can each extend up to the vicinity of the shaft bearing 10 or the structure of the pump housing 1 which forms the shaft bearing 10. Accordingly, the inner chamber inlets 6a and 6b and/or the inner chamber outlets 8a and 8b can be formed so as to immediately adjoin said shaft bearing structure radially.

Favorable flow conditions or low flow resistances are achieved in the low-pressure region of the pump housing 1 in particular when the inflow is linear, for example linear in the radial direction, from the opening of the housing inlet 2 up to the inner chamber inlets 6a and 6b. In the high-pressure region of the pump housing 1, advantageous flow conditions, i.e. low flow resistances, are achieved in particular in embodiments in which the central drainage line 3a and the housing outlet 3 extend linearly and advantageously in the radial direction from the outer opening of the housing outlet 3 up to the inner chamber outlets 8a and 8b. By guiding the flow in this way, it is possible to realize short flow paths and additionally to facilitate manufacture. It is also advantageous for manufacturing, but also for achieving short flow paths, if the feed channels 7a and 7b which divert from the central feed line 2a on the left and right and/or the drainage channels 9a and 9b which divert from the central drainage line 3a on the left and right extend linearly and in the axial direction. The feed channels 7a and 7b and the drainage channels 9a and 9b can widen axially to a certain extent, for example conically, towards the front-facing sides of the pump housing 1 in order to facilitate forming them in a casting process.

An electric drive motor 45 is indicated in FIG. 2 which is coupled to the drive shaft 40 for rotary-driving the sets of rotors 11 and 14. As likewise indicated by dashed lines in FIG. 2, the drive motor 45 or an engine housing which accommodates the drive motor 45 can be fastened to a front-facing side of the pump housing 1 in an axial extension of the pump housing 1 or can instead be arranged offset transversely to the drive shaft 40 and connected to the pump housing 1. In principle, however, a drive motor 45 can also be arranged separately from the pump housing 1 and suitably coupled to the drive shaft 40, for example via a gear system. Preferably, however, it is coaxially arranged, wherein the drive shaft 40 also directly forms the motor shaft of the drive motor 45 or is non-rotationally connected to the motor shaft. Providing drive via a gear system, for example a spur gear system, a chain or a belt, is not however to be ruled out.

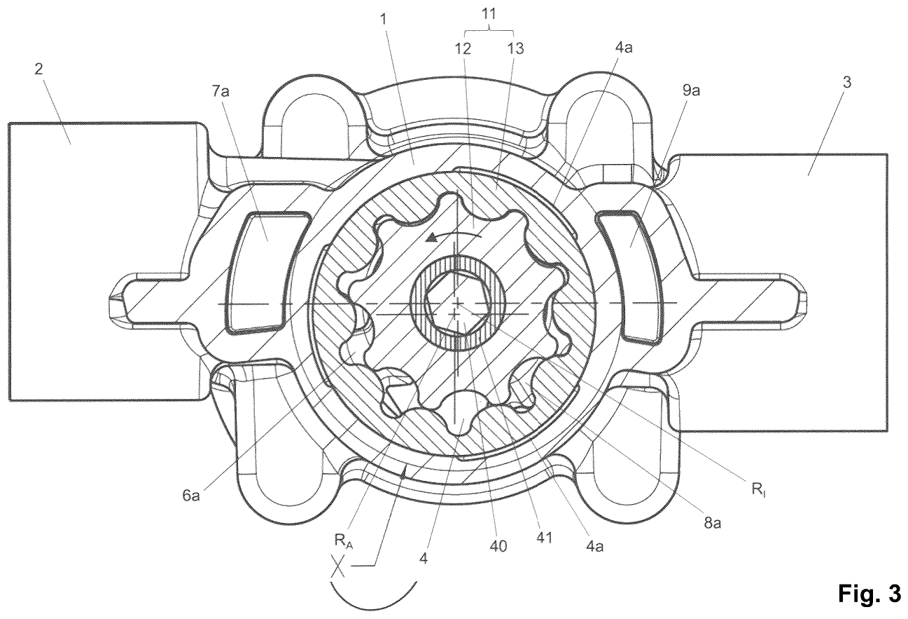

FIG. 3 shows the toothed wheel pump in a cross-section in the region of the delivery chamber 4 in an axial view onto the housing inlet 2 and the housing outlet 3. The inner rotor 12 is non-rotationally connected to the bearing sleeve 41 in a frictional fit. The bearing sleeve 41 is non-rotationally connected to the drive shaft 40 in a positive fit, but preferably such that it can be translated axially. The conditions are similar for the other set of rotors 14. If the inner rotor 12 is driven in the rotational direction indicated by the directional arrow in FIG. 3, for example counterclockwise, the delivery cells formed by the toothed engagement between the rotors 12 and 13 increase in size in the low-pressure region of the delivery chamber 4 with each revolution and then decrease in size again in the high-pressure region of the delivery chamber 4. The inner chamber inlet 6a and the outer chamber inlet 21 (FIG. 2) emerge in the low-pressure region of the delivery chamber 4. The inner chamber outlet 8a and the outer chamber outlet 22 (FIG. 2) each emerge in the high-pressure region of the delivery chamber 4. The fluid flowing into the low-pressure region is delivered in the respective delivery cell via a region of minimum toothed engagement into the high-pressure region, where the delivery cells decrease in size and so expel the fluid from the delivery chamber 4. The high-pressure region is adjoined in the rotational direction by a region of maximum toothed engagement which the delivery cells pass through before increasing in size again in the low-pressure region.

As already mentioned, the delivery chamber 4 is delimited on its inner front-facing side axially facing the delivery chamber 5 by the central housing front-facing wall and on its outer front-facing side which faces axially away from the delivery chamber 5 by the housing cover 20. The central housing front-facing wall also delimits the delivery chamber 5 on its inner front-facing side axially facing the delivery chamber 4, while the other housing cover 30 axially delimits the delivery chamber 5 on its outer front-facing side which faces away from the delivery chamber 4. The central housing front-facing wall and similarly the housing covers 20 and 30 each comprise a separating stay in the region of maximum toothed engagement of the respective set of rotors 11 and 14 and in the region of minimum toothed engagement, in order to fluidically separate the high-pressure region of the respective delivery chamber 4 and 5 from the low-pressure region of the respective delivery chamber 4 and 5 both in the region of maximum toothed engagement and in the region of minimum toothed engagement.

The rotational axes which extend eccentrically with respect to each other, namely the rotational axis R_{I} of the drive shaft 40 and the two inner rotors 12 and 15 on the one hand and the rotational axis R_{A} of the two outer rotors 13 and 16 which is eccentric with respect to the rotational axis R_{I} on the other, are also indicated in FIG. 3.

The outer rotors (in FIG. 3, the first outer rotor 13) are rotatably mounted in a sliding manner on the circumferential wall of the respective delivery chamber 4 and 5. The circumferential wall of the respective delivery chamber 4 and 5 therefore forms a radial rotary slide bearing over the outer circumference of the respective outer rotor 13 and 16. Recesses 4a, in which fluid collects when the pump is in operation, are formed on the inner circumference of the circumferential wall of the first delivery chamber 4. Other such recesses are formed on the inner circumference of the circumferential wall of the second delivery chamber 5. The recesses 4a and the recesses in the circumferential wall of the delivery chamber 5 improve the lubrication of the outer circumferential surfaces of the outer rotors 13 and 16, which are opposite each other in the respective rotary slide bearing, on the one hand and the inner circumferential surfaces of the delivery chambers 4 and 5 on the other. In particular, the radial shear gradient of the fluid in the circumferential gap is decreased in the region of the respective recess, which in turn helps to decrease the frictional output. The recesses 4a can extend over the entire axial length of the outer rotors 13 and 16. They can instead also extend, each in one axial direction only, up to the front-facing end of the respective outer rotor 13 and 16. In another alternative, they can each be formed as a pocket and terminate in both axial directions short of the axial front-facing end of the respective outer rotor 13 and 16, such that an uninterrupted circumferential edge strip remains at both front-facing ends over the outer circumference of the respective outer rotor 13 and 16. By way of example, three recesses 4a and corresponding recesses on the inner circumference of the second delivery chamber 5 are provided in an equally spaced distribution around the rotational axis R_{A}.

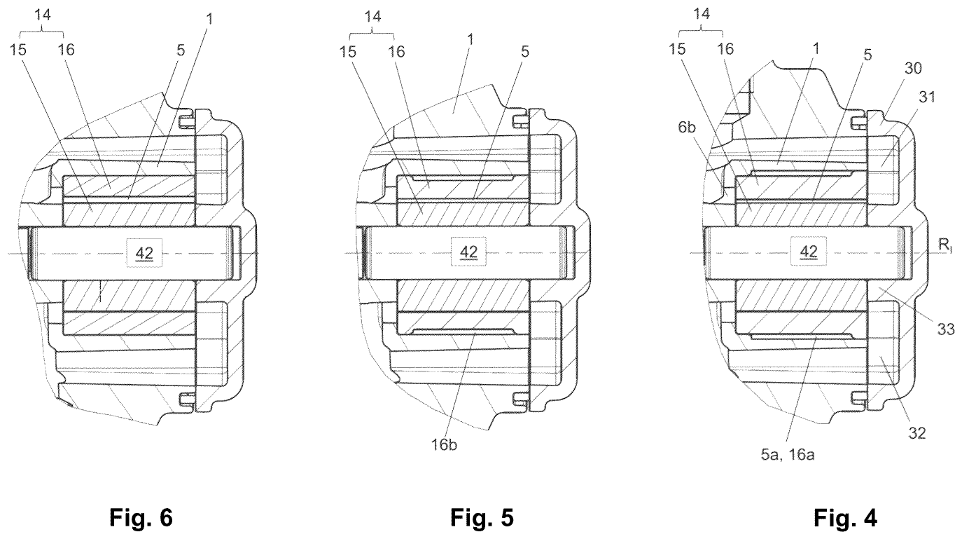

FIG. 4 shows a first variant of a rotational mounting as another example of decreasing the frictional output, wherein the delivery chamber 5 shown is also intended to represent the delivery chamber 4. In the first variant, the delivery chambers 4 and 5 comprise a comparatively wide first or outer chamber axial portion 5a on the axially outer side and, adjoining it on the axially inner side, a second or inner chamber axial portion which is radially narrower by comparison. Accordingly, the outer rotors 13 and 16 likewise comprise a radially comparatively wide first or outer rotor axial portion on the axially outer side and, adjoining it on the axially inner side, a second or inner rotor axial portion 16a which is radially narrower by comparison. As a result, a strip-shaped support gap is obtained in the inner axial portion of the respective delivery chamber 4 and 5 and in the outer axial portion of the respective outer rotor 13 and 16 and, axially between these two, a radially comparatively wide gap which can be filled with fluid. The wide outer axial portion of the delivery chamber 5 is denoted by 5a, and the inner axial portion of the outer rotor 16 having a reduced diameter is denoted by 16a. The overlap region 5a, 16a is delimited on the axially inner side and on the axially outer side by the respective support gap.

FIG. 5 shows a second variant of the rotational mounting for decreasing the frictional output, wherein the delivery chamber 5 shown is again intended to represent the delivery chamber 4. In the second variant, the inner circumference of the pump housing 1 which surrounds the respective delivery chamber 4 and 5 exhibits a constant diameter over the length of the delivery chamber 4 or 5. The outer rotors 13 and 16, by contrast, each comprise a circumferential recess on their outer circumference, wherein the recess 16b of the second outer rotor 16 in FIG. 5 is representative of an identical recess on the outer rotor 13. The second variant therefore also provides two strip-shaped circumferential support gaps and, axially between the support gaps, a radially comparatively wide circumferential gap which can be filled with the fluid.

FIG. 6 shows a third variant of the rotational mounting, wherein the delivery chamber 5 shown is again intended to represent the delivery chamber 4. The third variant is shown primarily for the sake of completeness. In the third variant, measures to decrease the frictional output generated in the circumferential gap subject to losses are omitted. The outer rotors 13 and 16 have a simple, circularly cylindrical, smooth outer circumference over their entire length. Similarly, the delivery chambers 4 and 5 each have a simple, circularly cylindrical, smooth inner circumference over their entire length.

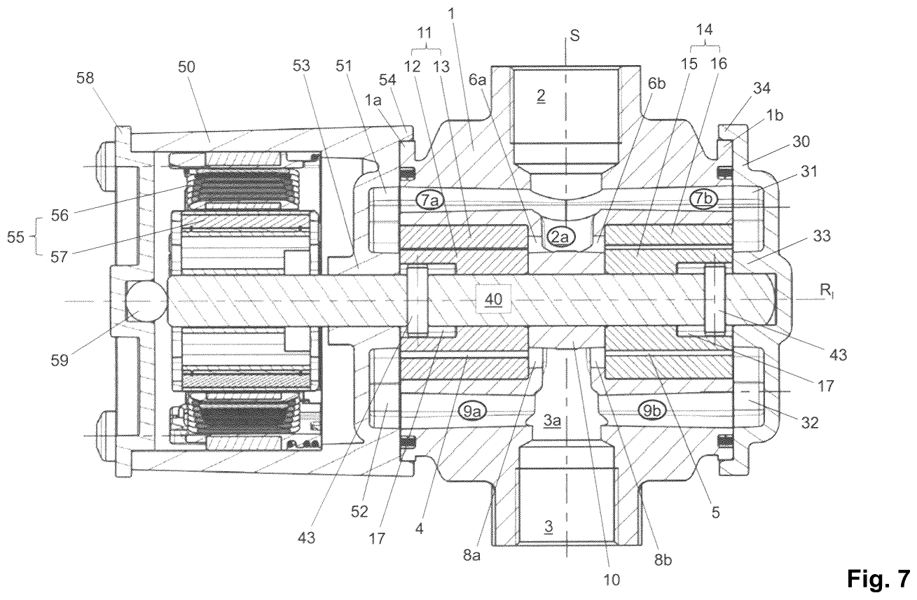

FIG. 7 shows an internal-axle toothed wheel pump of a second example embodiment, in a longitudinal section in which the rotational axis RI of the drive shaft 40 extends. With regard to guiding the fluid from the housing inlet 2 up to and including the housing outlet 3, and also with regard to the delivery chambers 4 and 5, the pump housing 1 functionally and geometrically corresponds exactly to the pump housing 1 of the first example embodiment, such that the same reference signs as in the first example embodiment are used for the corresponding housing structures.

A first difference exists on the drive side of the pump housing 1, where the drive shaft 40 protrudes out of the pump housing 1. An electric drive motor 55 is arranged coaxially with the drive shaft 40 on the drive side and coupled to the drive shaft 40 in order to transmit torque. The drive motor 55 is accommodated in an engine housing 50 which is fastened to the pump housing 1.

The drive side of the pump housing 1 comprises a centring structure 1a for centring the engine housing 50 in relation to the rotational axis RI of the drive shaft 40. The engine housing 50 comprises a complementary centring structure 54 which co-operates with the centring structure 1a of the pump housing 1 when centring the engine housing 50. The centring structure 1a exhibits an outer circumference which encircles the rotational axis R_{I}. An inner circumference which likewise encircles the rotational axis RI when assembled is formed on the complementary centring structure 54 which is for example formed by a centring collar which protrudes axially on the front-facing side of the engine housing 50. The outer circumference of the centring structure 1a and the inner circumference of the complementary centring structure 54 are manufactured to fit each other, such that the engine housing 50 is centered on the pump housing 1 in relation to the rotational axis R_{I} when the complementary centring structure 54 encompasses the centring structure 1a in a centring engagement. In a modification, the centring structure 1a can be provided with the inner circumferential surface and the complementary centring structure 54 can be provided with the outer circumferential surface, such that the centring structure 1a encompasses the complementary centring structure 54 in the modified centring engagement.

The engine housing 50 comprises a circumferential wall, which surrounds an engine space, and forms a front-facing wall for the pump housing 1 on the drive side of the pump housing 1. This front-facing wall comprises a hollow-shaped outer chamber inlet 51 axially opposite the low-pressure region of the first delivery chamber 4 and a hollow-shaped outer chamber outlet 52 axially opposite the high-pressure region of the delivery chamber 4. In relation to the chamber inlet 51 and chamber outlet 52, the engine housing 50 corresponds to the housing cover 20 of the first example embodiment. As in the first example embodiment, the outer chamber inlet 51 connects the feed channel 7a to the low-pressure region of the delivery chamber 4, and the chamber outlet 52 connects the high-pressure region of the delivery chamber 4 to the drainage channel 9a.

The drive motor 55 comprises a stator 56, which is non-rotationally connected to the engine housing 50, and a rotor 57 which is non-rotationally connected to the drive shaft 40. The drive shaft 40 is simultaneously the motor shaft of the drive motor 55. In modifications, the drive shaft 40 and the motor shaft can be connected to each other via a coupling. The drive shaft 40 and the motor shaft are however advantageously coaxial with each other even in these modifications.

The drive shaft 40 protrudes freely through the front-facing wall of the engine housing 50 and into the engine space. The engine housing 50 forms a shaft bearing 53 for the drive shaft 40 in the region of the front-facing wall. The shaft bearing 53 can in particular be formed as a radial slide bearing. The shaft portion of the drive shaft 40 which protrudes via the shaft bearing 53 into the engine space of the engine housing 50 is not otherwise radially supported, i.e. the drive shaft 40 supports the rotor 57 in a radially floating manner.

An engine cover 58 closes off the engine housing 50 on its front-facing side which faces axially away from the pump housing 1. The drive shaft 40 can be axially supported on the engine cover 58. In the example embodiment, a centring element 59 which is for example spherical is accommodated in a receptacle of the engine cover 58, and the drive shaft 40 is directly supported on this centring element 59 in an axial contact.

A shaft bearing 10 can be provided axially between the sets of rotors 11 and 14. The shaft bearing 10 can be formed, as in the first example embodiment, in the region of the central front-facing wall of the pump housing 1 and can advantageously be formed as a radial slide bearing. Unlike the first example embodiment, the drive shaft 40 can be rotatably mounted and radially supported directly in the shaft bearing 10.

The housing cover 30 closes off the pump housing 1 on the front-facing side which faces axially away from the drive motor 55 and, as in the first example embodiment, comprises the outer chamber inlet 31 and the outer chamber outlet 32 for the second delivery chamber 5. It also comprises the shaft receptacle 33 which can be formed as another shaft bearing in the form of a radial rotary slide bearing. To this extent, the housing cover 30 of the second example embodiment corresponds to the housing cover 30 of the first example embodiment. The only difference is that the housing cover 30 is more precisely centered relative to the pump housing 1 in relation to the rotational axis R_{I} than in the first example embodiment. For the purposes of centring, the pump housing 1 comprises a centring structure 1b and the housing cover 30 comprises a complementary centring structure 34, which are in a centring engagement with each other by which they center the housing cover 30 relative to the pump housing 1.

The centring structure 1b exhibits an outer circumference which encircles the rotational axis R_{I}. An inner circumference which likewise encircles the rotational axis R_{I} when assembled is formed on the complementary centring structure 34 which is for example formed by a centring collar which protrudes axially on the front-facing side of the housing cover 30. The outer circumference of the centring structure 1b and the inner circumference of the complementary centring structure 34 are manufactured to fit each other, such that the housing cover 30 is centered on the pump housing 1 in relation to the rotational axis R_{I} when the complementary centring structure 34 encompasses the centring structure 1b in a centring engagement. In a modification, the centring structure 1b can be provided with the inner circumferential surface and the complementary centring structure 34 can be provided with the outer circumferential surface, such that the centring structure 1b encompasses the complementary centring structure 34 in the modified centring engagement.

The drive shaft 40 is axially supported on the housing cover 30 in the region of the shaft receptacle 33.

In the second example embodiment, the drive shaft 40 is radially supported in the shaft bearing 53 and additionally between the sets of rotors 11 and 14 in the shaft bearing 10. As already mentioned, the shaft receptacle 33 can likewise form a radial rotary slide bearing for the drive shaft 40. If the shaft receptacle 33 is formed as a radial bearing, i.e. as a radial support, the shaft bearing 10 can be omitted in a modification. It would in principle also be sufficient for it to be radially mounted by the shaft bearing 53 only. In other modifications, the drive shaft 40 can be radially supported on the side which faces axially away from the pump housing 1, for example on the engine cover 58, in addition to being supported in the shaft bearing 53. Preferably, however, the rotor 57 is radially overhung.

In the second example embodiment, the bearing sleeves 41 and 42 of the first example embodiment are omitted. In order to be rotationally slaved, the drive shaft 40 is non-rotationally coupled directly to the first inner rotor 12 and directly to the second inner rotor 15 in a positive fit. Advantageously, the inner rotors 12 and 15 can be axially moved relative to the drive shaft 40 and relative to each other in their respective coupling engagement with the drive shaft 40.

The drive shaft 40 is coupled in a positive fit or rotationally slaved by transverse pins which engage with grooves. For the purposes of coupling, transverse pins 43 extend through the drive shaft 40. The inner rotors 12 and 15 each comprise two axial grooves 17 on their inner circumference which surrounds the drive shaft 40, wherein the respective transverse pin 43 engages with said groove 17. The grooves 17 are formed to narrowly fit the transverse pins 43 in order to achieve the positive-fit coupling. The grooves 17 extend, from the front-facing sides of the inner rotors 12 and 15 which face axially away from each other, slightly towards each other in the axial direction. They are each formed as a blind groove. Non-rotationally coupling them directly, preferably by means of the transverse pins 43 and the engagement grooves 17, facilitates assembling the toothed wheel pump.

The pump housing 1 and the engine housing 50 can then (or in a later step) be joined to each other, for example by means of a screw connection. In another step, the second set of rotors 14 are pushed onto the drive shaft 40 and into the volume of the pump housing 1 which forms the second delivery chamber 5. In this state, the drive shaft 40 can be raised or shifted axially to a certain degree, in order to expose the bore for the second transverse pin 43, and the second transverse pin 43 can be inserted through the drive shaft 40. The drive shaft 40 is then axially retracted again, whereby the second transverse pin 43 enters a rotationally secured engagement with the grooves 17 of the second inner rotor 15. The housing cover 30 is then fastened to the pump housing 1, and the engine cover 58 is fastened to the engine housing 50. The toothed wheel pump is then fully assembled.

Aside from the differences described, the toothed wheel pump of the second example embodiment corresponds to the toothed wheel pump of the first example embodiment.

The toothed wheel pump in accordance with an aspect of the invention is in particular characterized in that the axial length of the respective set of rotors 11 and 14, as measured as the toothed engagement length, is unusually large in relation to the outer diameter of the respective outer rotor 13 and 16. This particular geometric feature can readily be seen in FIGS. 2 and 7.

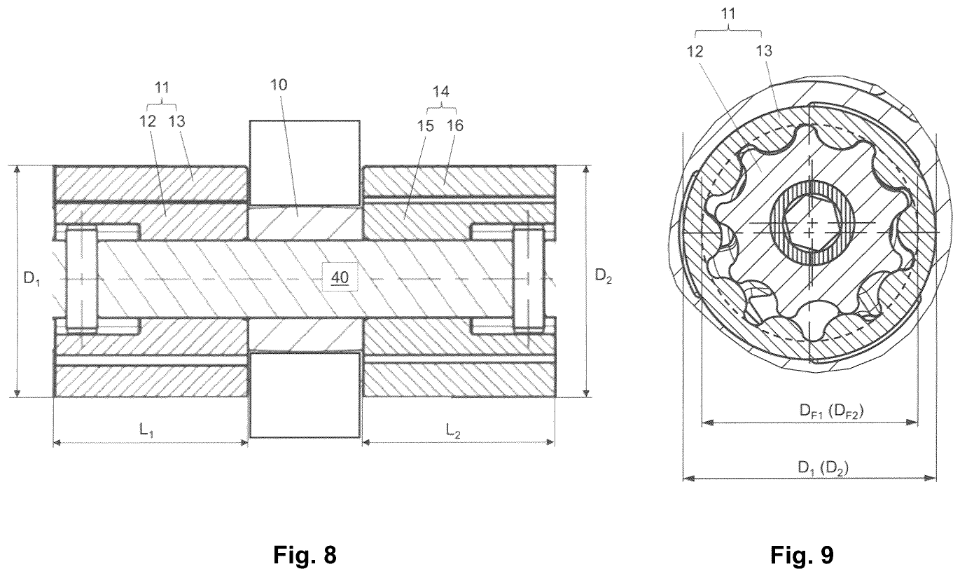

FIG. 8 shows the two sets of rotors 11 and 14 of the second example embodiment (FIG. 7) together with the drive shaft 40 and the shaft bearing 10 only. The toothed engagement length of the first set of rotors 11 is denoted by L₁, and the outer diameter of the first outer rotor 13 is denoted by D₁. The toothed engagement length of the second set of rotors 14 is denoted by L₂, and the outer diameter of the second outer rotor 16 is denoted by D₂. In order to decrease the frictional output at a given specific delivery volume and consequently increase the overall efficiency, the toothed engagement lengths L₁ and L₂ are larger in relation to the outer diameters D₁ and D₂ than in conventional toothed wheel pumps.

The following holds for the first set of rotors 11:

$${L}_{1} \geq 0.7 \times {D}_{2} or {L}_{2} \geq 0.8 \times {D}_{1} or {L}_{1} \geq 0.9 \times {D}_{1} ,$$

and the following holds for the second set of rotors 14:

$${L}_{2} \geq 0.7 \times {D}_{2} or {L}_{2} \geq 0.8 \times {D}_{2} or {L}_{2} \geq 0.9 \times {D}_{2} .$$

In order to prevent cavitation, it is advantageous if the following additionally holds for the first set of rotors 11 and the second set of rotors 14:

$${L}_{1} \leq 1.5 \times {D}_{1} or {L}_{1} \leq 1.3 \times {D}_{1}$$

$$and$$

$${L}_{2} \leq 1.5 \times {D}_{2} or {L}_{2} \leq 1.3 \times {D}_{2} .$$

In advantageous embodiments, the outer diameters D₁ and D₂ and/or the toothed engagement lengths L₁ and L₂ are identical. The rotors 12 and 13 of the first set of rotors 11 and/or the rotors 15 and 16 of the second set of rotors 14 can be identical in axial length.

The overall measured length of the rotors 12 and 13 of the first set of rotors 11 can correspond to the toothed engagement length L₁. The respective overall measured length of the rotors 15 and 16 of the second set of rotors 14 can correspond to the toothed engagement length L₂.

FIG. 9 substantially shows the rotors 12 and 13 of the first set of rotors 11 only. This detailed representation is taken from FIG. 3. The outer diameter of the first outer rotor 13 is again denoted by D₁. The diameter of the root circle of the first outer rotor 13 is denoted by D_{F1}. At least one of the following relationships can in particular hold for the outer diameter of the outer rotor 13 and for the root circle diameter of the outer rotor 13:

$${D}_{1} \leq 2 \times {D}_{F 1} or {D}_{1} \leq 1.5 \times {D}_{F 1} .$$

The outer diameter D₂ of the second outer rotor 16 and the root circle diameter D_{F2} of the second outer rotor 16 are indicated in brackets in FIG. 9. To this extent, the depiction of the first set of rotors 11 is representative of the second set of rotors 14. In the second set of rotors 14, the following advantageously holds for the outer diameter and the root circle diameter of the second outer rotor 16:

$${D}_{2} \leq 2 \times {D}_{F 2} or {D}_{2} \leq 1.5 \times {D}_{F 2} .$$

The statements regarding the dimensions of the rotors 12, 13, 15 and 16 hold for both example embodiments. The sets of rotors 11 and 14 of the example embodiments differ only with regard to how they are coupled to the drive shaft 40, in that the inner rotors 12 and 15 are arranged on the drive shaft 40 via the bearing sleeves 41 and 42 in the first example embodiment and are arranged directly on the drive shaft 40 in the second example embodiment.

In advantageous embodiments, the inner rotors 12 and 13 are identical and/or the outer rotors 13 and 16 are identical. In such embodiments, the inner rotors 12 and 15 can be interchanged and/or the outer rotors 13 and 16 can be interchanged in the respective example embodiment.

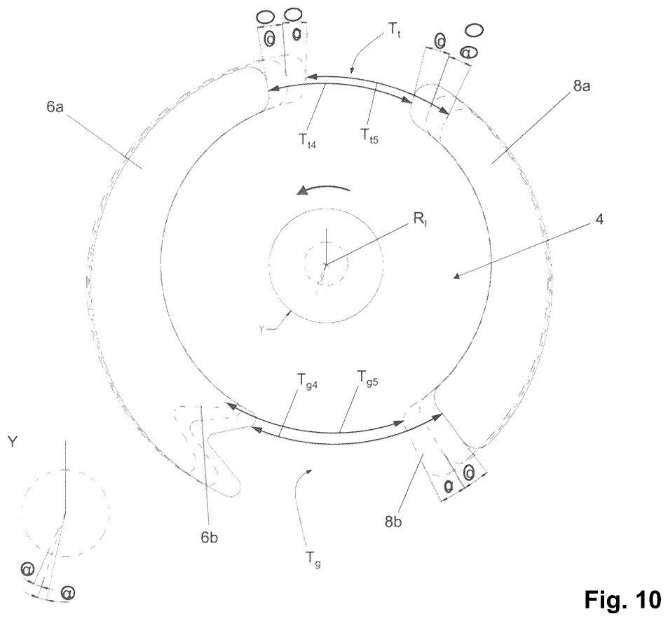

FIG. 10 is a front-facing view onto the inner front-facing wall of the first delivery chamber 4. The inner chamber inlet 6a and the inner chamber outlet 8a extend in said front-facing wall. The chamber inlet 6a extends in the shape of a kidney around the rotational axis RI in the low-pressure region of the delivery chamber 4, and the chamber outlet 8a extends over the rotational axis R_{I} on the opposite side, likewise in the shape of a kidney around the rotational axis R_{I}, in the high-pressure region of the delivery chamber 4. The front-facing wall forms a separating stay Tₜ₄ in the region of maximum toothed engagement (FIG. 3) and a separating stay T_{g4} in the region of minimum toothed engagement. The separating stays each extend in the circumferential direction between the chamber inlet 6a and the chamber outlet 8a and each form an axial sealing gap with the front-facing side of the rotors 12 and 13 facing them, in order to fluidically separate the high-pressure region from the low-pressure region of the delivery chamber 4 when the pump is in operation.

The inner front-facing wall of the delivery chamber 4 which is formed by the pump housing 1 is simultaneously also an inner front-facing wall of the delivery chamber 5 (FIGS. 2 and 7). The inner chamber inlet 6b and the inner chamber outlet 8b of the second delivery chamber 5 emerge in the front-facing wall on the other front-facing side which faces away from the delivery chamber 4, as can be seen for example in FIGS. 2 and 7. The inner chamber inlet 6b and the inner chamber outlet 8b of the second delivery chamber 5 are shown by dashed lines in FIG. 10. The chamber inlets 6a and 6b are preferably identical in outline. The chamber outlets 8a and 8b are likewise preferably identical in outline.

In the axial view in FIG. 10, the inner chamber inlet 6a and the inner chamber inlet 6b broadly overlap. Similarly, the inner chamber outlets 8a and 8b also broadly overlap. However, the separating stays of the two delivery chambers 4 and 5 are offset with respect to each other in the circumferential direction. The angular offset, measured as an arc angle around the rotational axis RI of the drive shaft 40, measures 2α. Accordingly, the rotational angular position of the chamber inlet 6b with respect to the chamber inlet 6a and the rotational angular position of the chamber outlet 8b with respect to the chamber outlet 8a are offset by the angle 2α in relation to the rotational axis R_{I}. The two separating stays Tₜ₄ and T_{g4} are indicated with regard to their extent in the circumferential direction by double-headed arrows or elongated arrows extending in the circumferential direction. The separating stay Tₜ₅ of the second delivery chamber 5 located in the region of maximum toothed engagement and the separating stay T_{g5} of the second delivery chamber 5 located in the region of minimum toothed engagement are each superimposed in FIG. 10 as an elongated arrow. The angular offset can be clearly seen when comparing the elongated arrows. The angular offset is additionally given in comparison with a zero offset. The chamber inlet 6a and the chamber outlet 8a of the delivery chamber 4 are offset in one circumferential direction by the angle α, and the chamber inlet 6b and the chamber outlet 8b of the second delivery chamber 5 are offset in the other circumferential direction, likewise by the angle α, in relation to the rotational angular position with no (zero) offset.

The separating stays of the outer front-facing wall of the first delivery chamber 4 which are formed by the housing cover 20 or the engine housing 50 are axially aligned with the separating stays Tₜ₄ and T_{g4}. Similarly, two separating stays formed by the housing cover 30 on the outer front-facing wall of the second delivery chamber 5 are axially aligned with the separating stays Tₜ₅ and T_{g5}. The separating stays on these outer front-facing walls of the delivery chambers 4 and 5 therefore exhibit the same angular offset 2α relative to each other.

The angular offset 2α in the first delivery chamber 4 is advantageously smaller than a tooth width of the first outer rotor 13 as measured in the circumferential direction on the pitch circle. In the second delivery chamber 5, the angular offset 2α is advantageously smaller than a tooth width of the second outer rotor 16 as measured in the circumferential direction on the pitch circle. In advantageous embodiments, the angular offset 2α in the respective delivery chamber 4 and 5 is smaller than three quarters of the tooth width of the respective outer rotor 13 and 16 as measured on the pitch circle. The angular offset 2α advantageously measures at least a quarter of the tooth width of the first outer rotor 12 as measured on the pitch circle in the first delivery chamber 4 and/or at least a quarter of the tooth width of the second outer rotor 16 as measured on the pitch circle in the second delivery chamber 5. It is particularly favorable if the angular offset 2α corresponds to a third of the tooth width of the first outer rotor 12 as measured in the circumferential direction on the pitch circle and/or a third of the tooth width of the second outer rotor 14 as measured in the circumferential direction on the pitch circle. The outer rotors 13 and 16 can differ from each other with regard to their internal teeth; preferably, however, the two sets of internal teeth are identical. The same holds for the external teeth of the inner rotors 12 and 15.

Due to the angular offset of the separating stays and accordingly the angular offset of the chamber inlets and chamber outlets of the first delivery chamber 4 with respect to the second delivery chamber 5, the expelling process of the set of rotors 11 is phase-shifted relative to the set of rotors 14 in accordance with the angular offset 2α. Accordingly, the pressure in the high-pressure region of the first delivery chamber 4, when plotted against the rotational angular position, is phase-shifted by the angular offset 2α with respect to the pressure profile in the second delivery chamber 5. This results in a more uniform pressure profile relative to a toothed wheel pump with no angular offset.

Instead of the angular offset of the separating stays or chamber inlets on the one hand and the angular offset of the chamber outlets on the other hand in accordance with an aspect of the invention, the sets of rotors 11 and 14 could conversely be arranged at an angular offset with respect to each other. An angular offset of the separating stays does however have the advantage that there is no need to take precautions to ensure that the sets of rotors are correctly arranged at an angular offset.

### REFERENCE SIGNS

1 pump housing
1a centring structure
1b centring structure
2 housing inlet
2a feed line
3 housing outlet
3a drainage line
4 first delivery chamber
4a recess
5 second delivery chamber
5a chamber axial portion
6a inner chamber inlet
6b inner chamber inlet
7a feed channel
7b feed channel
8a inner chamber outlet
8b inner chamber outlet
9a drainage channel
9b drainage channel
10 shaft bearing
11 first set of rotors
12 first inner rotor
13 first outer rotor
13a recess
14 second set of rotors
15 second inner rotor
16 second outer rotor
16a rotor axial portion
16b recess
17 rotational slaving means, groove
20 housing cover
21 outer chamber inlet
22 outer chamber outlet
23 shaft receptacle
24
25 gasket
30 housing cover
31 outer chamber inlet
32 outer chamber outlet
33 shaft receptacle
34 complementary centring structure, centring collar
35 gasket
40 drive shaft
41 bearing sleeve
42 bearing sleeve
43 rotational slaving means, transverse pin
44
45 drive motor
50 engine housing
51 outer chamber inlet
52 outer chamber outlet
53 shaft bearing
54 complementary centring structure, centring collar
55 drive motor
56 stator
57 rotor
58 engine cover
59 centring element
2α angular offset
D₁ outer diameter of the outer rotor
D₂ outer diameter of outer rotor
D_{K1} tip circle diameter of the inner rotor
D_{K2} tip circle diameter of the inner rotor
L₁ toothed engagement length
L₂ toothed engagement length
R_{A} rotational axis of the outer rotor
R_{I} rotational axis of the inner rotor
S transverse axis
Tₜ₄ separating stay
Tₜ₅ separating stay
T_{g4} separating stay
T_{g5} separating stay

1-15. (canceled)

16. A toothed wheel pump for delivering a hydraulic fluid, for example a cooling fluid and/or a lubricating fluid, the toothed wheel pump comprising:
a pump housing featuring a housing inlet and a housing outlet for the fluid, and a first delivery chamber and second delivery chamber which are connected to the housing inlet and the housing outlet;
a drive shaft;
a first set of internal-axle rotors which are coupled to the drive shaft and can be rotated in the first delivery chamber and comprise an externally toothed first inner rotor and an internally toothed first outer rotor which are in a first toothed engagement in order to deliver fluid from the housing inlet to the housing outlet; and
a second set of internal-axle rotors which are coupled to the drive shaft and can be rotated in the second delivery chamber and comprise an externally toothed second inner rotor and an internally toothed second outer rotor which are in a second toothed engagement in order to deliver fluid, wherein
an axial engagement length of the first toothed engagement corresponds to at least 0.7 times the outer diameter of the first outer rotor and/or
an axial engagement length of the second toothed engagement corresponds to at least 0.7 times the outer diameter of the second outer rotor.

17. The toothed wheel pump according to claim 16, wherein the axial engagement length of the first toothed engagement corresponds to at most 1.5 times or 1.3 times the outer diameter of the first outer rotor and/or the axial engagement length of the second toothed engagement corresponds to at most 1.5 times or 1.3 times the outer diameter of the second outer rotor.

18. The toothed wheel pump according to claim 16, wherein the outer diameter of the first outer rotor corresponds to at most twice or 1.5 times the root circle diameter of the first outer rotor and/or wherein the outer diameter of the second outer rotor corresponds to at most twice or 1.5 times the root circle diameter of the second outer rotor.

19. The toothed wheel pump according to claim 16, wherein the second set of rotors is hydraulically connected in parallel with the first set of rotors in order to likewise deliver fluid from the housing inlet to the housing outlet.

20. The toothed wheel pump according to claim 16, wherein
a front-facing side of the first delivery chamber axially faces opposite a front-facing side of the second delivery chamber,
the pump housing comprises a feed line, which is connected to the housing inlet, and a drainage line which is connected to the housing outlet, and
the feed line and/or the drainage line extends up to and between the mutually facing front-facing sides of the delivery chambers.

21. The toothed wheel pump according to claim 16, wherein
a front-facing side of the first delivery chamber axially faces opposite a front-facing side of the second delivery chamber and
the housing inlet is provided on a circumferential wall of the housing and surrounds a virtual straight line which extends between the mutually facing front-facing sides of the delivery chambers, orthogonally with respect to a rotational axis of the first set of rotors and/or second set of rotors, and/or
the housing outlet is provided on a circumferential wall of the housing and surrounds a virtual straight line which extends between the mutually facing front-facing sides of the delivery chambers, orthogonally with respect to a rotational axis of the first set of rotors and/or second set of rotors.

22. The toothed wheel pump according to claim 16, wherein at least one of the sets of rotors can be filled with the fluid on both front-facing sides and/or the fluid can be expelled on both front-facing sides of at least one of the sets of rotors.

23. The toothed wheel pump according to claim 16, wherein the first inner rotor and/or the second inner rotor is/are non-rotationally connected to the drive shaft.

24. The toothed wheel pump according to claim 23, wherein the first inner rotor and/or the second inner rotor is/are joined to the drive shaft in a positive fit and/or frictional fit.

25. The toothed wheel pump according to claim 23, wherein
the first inner rotor and/or the second inner rotor surround(s) the drive shaft,
the first inner rotor and/or the second inner rotor comprises or each comprise a groove on an inner circumference, overlapping with the drive shaft, and
the drive shaft is provided with a transverse pin which protrudes from an outer circumference of the drive shaft and protrudes into the groove of the first inner rotor and/or into the groove of the second inner rotor,
such that the respective inner rotor is non-rotationally connected to the drive shaft in the engagement between the transverse pin and the groove.

26. The toothed wheel pump according to claim 16, comprising an electric drive motor featuring a stator and a rotor that is non-rotationally assembled on or on top of the drive shaft.

27. The toothed wheel pump according to claim 26, wherein the rotor is joined to the drive shaft in a positive fit and/or frictional fit.

28. The toothed wheel pump according to claim 26, wherein the drive shaft supports the rotor in a radially floating manner.

29. The toothed wheel pump according to claim 26, wherein
the drive motor is arranged in an engine housing,
the drive shaft protrudes through a front-facing wall which extends axially between the pump housing and the engine housing, and
the front-facing wall forms a shaft bearing.

30. The toothed wheel pump according to claim 16, wherein the drive shaft is rotatably mounted in a shaft bearing of the pump housing, axially between the sets of rotors.

31. The toothed wheel pump according to claim 30, wherein the shaft bearing is a radial slide bearing.

32. The toothed wheel pump according to claim 30, wherein
the first delivery chamber exhibits a low-pressure region, a high-pressure region and a separating stay between the low-pressure region and the high-pressure region in the circumferential direction in order to fluidically separate the high-pressure region and the low-pressure region of the first delivery chamber from each other,
the second delivery chamber exhibits a low-pressure region, a high-pressure region and a separating stay between the low-pressure region and the high-pressure region in the circumferential direction in order to fluidically separate the high-pressure region and the low-pressure region of the second delivery chamber from each other, and wherein
the separating stay of the first delivery chamber exhibits an angular offset with respect to the separating stay of the second delivery chamber as measured in the circumferential direction about a rotational axis of the first set of rotors and/or second set of rotors, such that when the sets of rotors rotate, the expelling process of the first set of rotors per revolution and the expelling process of the second set of rotors per revolution are phase-shifted in accordance with the angular offset.

33. The toothed wheel pump according to claim 32, wherein the angular offset measures at least a quarter and at most three quarters of a tooth width of the first outer rotor as measured in the circumferential direction on the pitch circle and/or at least a quarter and at most three quarters of a tooth width of the second outer rotor as measured in the circumferential direction on the pitch circle.

34. A cooling and/or lubricating circuit of an electrically driven and/or combustion-driven motor vehicle, wherein the cooling and/or lubricating circuit comprises the toothed wheel pump according to claim 16, which is designed to deliver a cooling and/or lubricating fluid in the cooling and/or lubricating circuit.

35. The toothed wheel pump according to claim 34, wherein the toothed wheel pump delivers the fluid for directly cooling a vehicle traction battery.
